(19) United States
(12) Patent Application Publication
(10) Pub. No.: US 2004/0074829 A1
(43) Pub. Date: Apr. 22, 2004

(54) Apparatus and method for improving water quality of reservoir

(76) Inventor: Paek Ki Kim, Chollabuk-do (KR)

Correspondence Address: Roth & Goldman, Professional Association, Suite 707, 523 West 6th Street, Los Angeles, CA, 90014, US

(21) Appl. No.: 10/415,796

(22) PCT Filed: Nov. 2, 2001
(86) PCT No.: PCT/KR01/01863

(30) Foreign Application Priority Data
Nov. 6, 2000 (KR) 2000/065612

(51) Int. Cl. B01D 21/30

(52) U.S. Cl. 210/143; 210/747; 210/170; 210/242.1

(57) ABSTRACT

An apparatus and a method for improving the water quality of a reservoir are disclosed. In the present invention, the surface water of the reservoir is circulated into the deep layers of the reservoir in a forcible manner, and therefore, the solute oxygen is diffused even into the deep layers of the reservoir. Accordingly, even if a turbid state occurs, living creatures can be sufficiently proliferated. Further, the hydrogen ion concentration is maintained at the neutral level, and therefore, the water of the reservoir is self-purified in a natural manner. The apparatus for improving the water quality of a reservoir includes the following elements. That is, a base plate is made to float upon the water surface of the reservoir, and a branched surface water guiding pipe is installed under the bottom of the base plate. A screw is installed within the guiding pipe, for being driven by a power, whereby the surface water is forcibly circulated into the deep layer of the reservoir.

### FIELD OF THE INVENTION

The present invention relates to an apparatus and a method for improving the water quality of a reservoir. Particularly, the present invention relates to an apparatus and a method for improving the water quality of a reservoir, in which the surface water is forcibly circulated into a deep layer of the reservoir, so that the reservoir water can be maintained in a wholesome status, thereby making various living creatures proliferate.

### BACKGROUND OF THE INVENTION

Generally, in reservoirs, if the water does not flow but remains stagnate, then the self-purifying capability is lowered. Accordingly, if contaminated or waste water is introduced, then hydrophytes such as green hydrophytes and red hydrophytes are grown, and therefore, the solute oxygen is exhausted, with the result that the water is stunk.

In order to prevent such phenomenon, the present inventor proposed a method for improving the water quality of reservoirs, filing a patent application for it under Patent Application number 1999-14996. According to this method, the water of the deep layer of the reservoir is forcibly circulated to the upper layer, and thus, the waters of the upper and lower layers are made to form wild currents. Thus any insufficient components are complemented, and neutralization is realized, thereby improving the water quality of the reservoir.

In this method however, although the water of the deep layer can be made to efficiently flow upward so as to be mixed with the water of the surface layer, the mixed water cannot be efficiently circulated into the deep layer. Accordingly, the method was insufficient to mix the waters of the deep and surface layers, and to improve the overall water quality of the reservoir.

That is, there was no means by which the mixed water is made to be forcibly circulated into the deep layer. Accordingly, although there were some partial regional effects, there were no overall effects in improving the water quality of the reservoir.

### SUMMARY OF THE INVENTION

The present invention is intended to overcome the above described disadvantages of the conventional techniques.

Therefore it is an object of the present invention to provide an apparatus and a method for improving the water quality of a reservoir, in which the waters of the deep layer and the surface layer are made to effectively circulate to and from each other, and thus, the waters of the deep layer and the surface layer are effectively mixed, thereby improving the overall water quality of the reservoir.

In achieving the above object, the apparatus for improving the water quality of a reservoir according to the present invention includes: a base plate for floating upon the water surface of the reservoir; a branched surface water guiding pipe installed under the bottom of the base plate; and a screw installed within the guiding pipe, for being driven by a power, whereby the surface water is forcibly circulated into the deep layer of the reservoir.

According to the present invention, the surface water of the reservoir is circulated into the deep layer of the reservoir to be mixed with the water of the deep layer, and therefore, the water of the deep layer can be effectively neutralized. In the process of forcibly circulating the surface water into the deep layer, the water of the deep layer rises upward, and therefore, the waters of the surface layer and the deep layer can be effectively mixed, thereby improving the water quality of the reservoir.

### BRIEF DESCRIPTION OF THE DRAWINGS

The above object and other advantages of the present invention will become more apparent by describing in detail the preferred embodiment of the present invention with reference to the attached drawings in which:

FIG. 1 schematically illustrates an embodiment of the apparatus according to the present invention;

FIG. 2 is a perspective view showing the distribution means and the guiding pipe of FIG. 1; and

FIG. 3 is a block diagram showing the constitution of the control device according to the present invention.

### DETAILED DESCRIPTION OF THE PREFERRED EMBODIMENT

The present invention will be described in detail referring to the attached drawings.

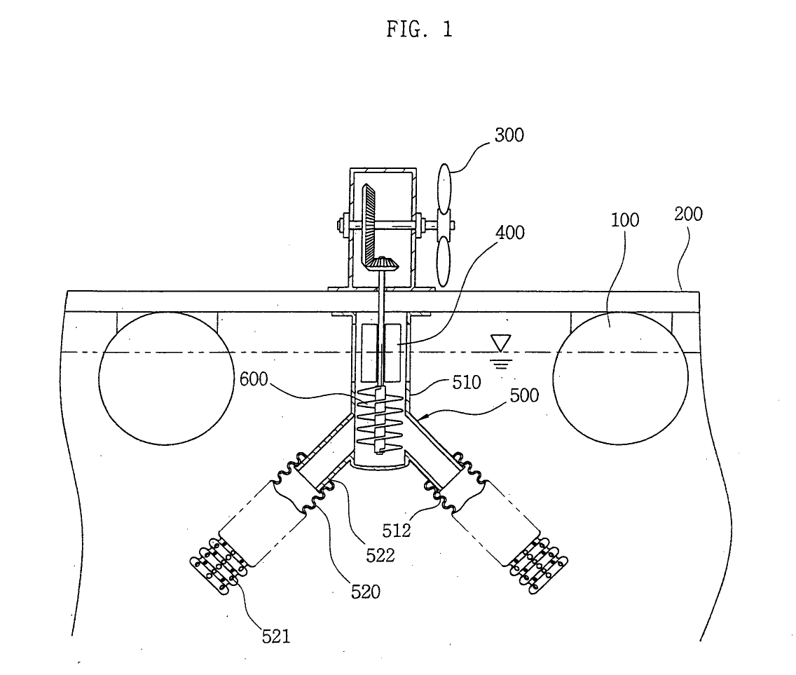

FIG. 1 schematically illustrates an embodiment of the apparatus according to the present invention.

As shown in this drawing, the apparatus for improving the water quality of a reservoir includes: a base plate 200 with a floating means 100 provided therein, for freely floating the base plate 200; a plurality of suction openings 400 formed under the base plate 200, for sucking the surface water of the reservoir; a branched guiding pipe 500 for discharging the surface water into deep layers of the reservoir after receipt of the surface water from the plurality of the suction openings 400; and a screw 600 installed within the branched guiding pipe 500, for driving the surface water into the deep layers of the reservoir.

The guiding pipe 500 includes: a distribution means 510 for distributing the surface water into a plurality of streams after receipt of the surface water through the suction openings 400; and a plurality of discharge tubes 520 coupled to branch pipes of the distribution means 510, for discharging the surface water into the deep layer of the reservoir.

Meanwhile, the screw 600 is driven by a driving means 300 which is installed upon the base plate 200. In the drawing, the driving means is operated by the wind force, but the use of an electric motor is not excluded.

Thus the screw-driving means drives the screw 600 which is installed within the branched guiding pipe 500. Thus owing to the forcible suction force of the screw 600, the surface water is introduced through the plurality of the suction openings 400 into the branched guiding pipe 500. Then the introduced water is discharged through the plurality of the discharge tubes 521 into the deep layer of the reservoir.

Now the operation of the apparatus will be described in detail.

The driving means 300 is driven by a wind force or by an electric power, and the power of the driving means 300 is transmitted through bevel gears to the screw 600 within the guiding pipe 500. Thus the surface water is sucked into the plurality of the suction openings 400 to be discharged into the deep layer of the reservoir.

Under this condition, the screw 600 is a multi-blade screw, and strong forces are required to push a large amount of the water. Accordingly, a plurality of blades are required, so that the surface water can reach the deep layer of the reservoir.

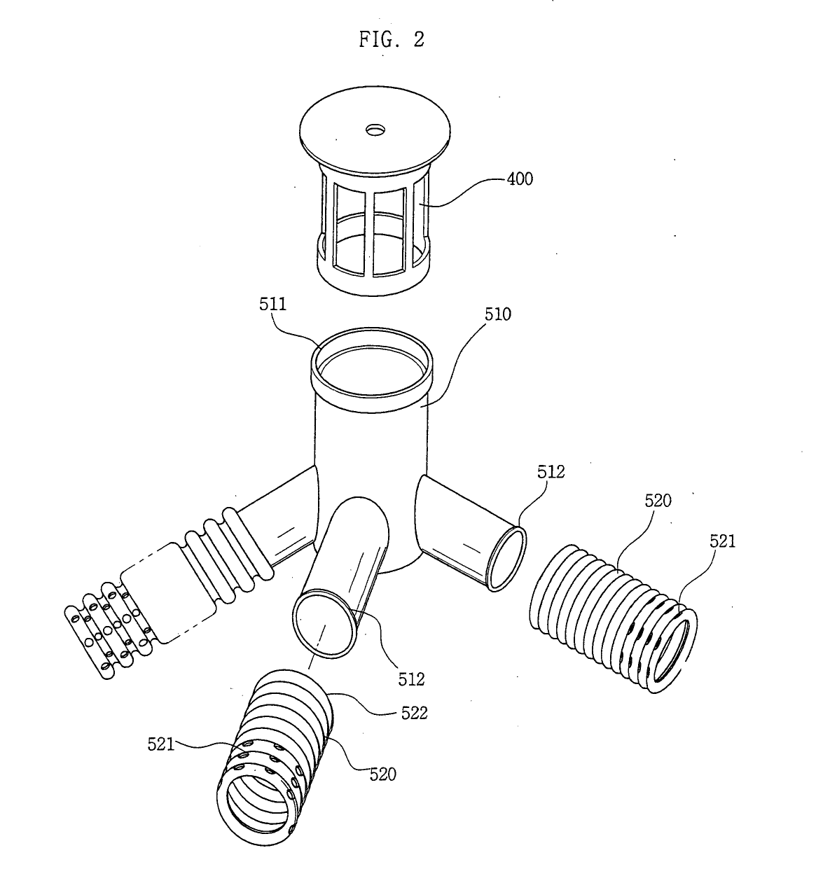

Meanwhile, the guiding pipe 500 which is installed under the suction openings 400 is for guiding the surface water into the deep layer of the reservoir, and this will be described referring to FIG. 2.

The guiding pipe 500 includes: a distribution means 510 and a plurality of discharge tubes 520. The distribution means 510 further includes: an upper coupling part 511 for being coupled to the lower portion of the suction opening frame; and a plurality of lower coupling parts 512 for being coupled to the plurality of the discharge tubes 520.

The plurality of the lower coupling parts 512 extend from the lower end of the distribution means 510, and thus, the surface water of the reservoir can be efficiently circulated to the deep layer of the reservoir.

Each of the discharge tubes 520 includes: a coupling part 522 for being coupled to each of the lower coupling parts 512; and a discharge hole 521 for discharging the surface water of the reservoir.

Meanwhile, a contamination sensor can be employed, so that the driving of the screw can be automatized in accordance with the contamination degree of the water of the reservoir. This will be described below.

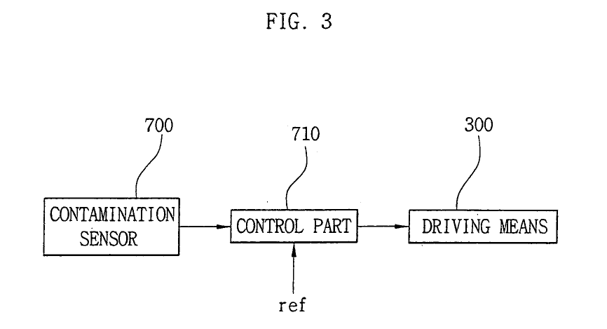

As shown in FIG. 3, a contamination sensor 700 is installed near the water surface of the reservoir to output a certain value in accordance with the contamination degree of the water of the reservoir. For example, the contamination sensor 700 may consist of a photo coupler.

This photo coupler is capable of sensing the turbidity of water. For example, if green hydrophytes or red hydrophytes are grown, then the turbidity is increased, and therefore, the photo coupler, i.e., the contamination sensor 700 can detect the turbidity to output the sensed value to a control part 710.

Upon receipt of the sensed value, the control part 710 compares the received value with a reference value, and thus, if the former exceeds the latter, then it is meant that a contamination has occurred. Accordingly, a driving command is outputted to a motor driving part 720 to drive the screw 600.

The contamination sensor 700 may consist of one of sensors other than the photo coupler.

In this manner, the surface water of the reservoir is forcibly circulated into the deep layers of the reservoir, and therefore, the hydrophytes of the surface water cannot survive after being carried into the deep layers, because they cannot make the photo assimilation.

Further, the solute oxygen which is over-saturated in the surface water is carried into the deep layers of the reservoir to be diffused widely. Accordingly, oxidation and the proliferation of the aerobic microbes are facilitated.

Further, the surface water in which the hydrogen ion concentration is high is mixed with the water of the deep layers in which the hydrogen ion concentration is low. Accordingly, the aerobic microbes are more proliferated.

According to the present invention as described above, the surface water of the reservoir is circulated into the deep layers in a forcible manner, and therefore, the solute oxygen is diffused even into the deep layers of the reservoir. Accordingly, even if a turbid state occurs, living creatures can be sufficiently proliferated. Further, the hydrogen ion concentration is maintained at the neutral level, and therefore, the water of the reservoir is self-purified in a natural manner.

What is claimed is:

1. A method for improving a water quality of a reservoir, characterized in that:
a base plate is made to float on a water surface of the reservoir;
a plurality of suction openings are formed under the base plate, for sucking a surface water of the reservoir;
a branched guiding pipe is coupled to a lower part of a suction opening frame; and
a screw installed within the guiding pipe, for forcibly driving the surface water into deep layers of the reservoir,
whereby the reservoir is made to have a self-purifying capability.

2. An apparatus for improving a water quality of a reservoir, comprising:
a base plate with a floating means provided therein, for freely floating the base plate;
a plurality of suction openings formed under the base plate, for sucking a surface water of the reservoir;
a branched guiding pipe for discharging the surface water into deep layers of the reservoir after receipt of the surface water from the plurality of the suction openings; and
a screw installed within the branched guide pipe, for driving the surface water into the deep layers of the reservoir;
the guiding pipe comprising:
a distribution means for distributing the surface water into a plurality of streams after receipt of the surface water through the suction openings; and
a plurality of discharge tubes coupled to branch pipes of the distribution means, for discharging the surface water into the deep layer of the reservoir.

3. The apparatus as claimed in claim 2, wherein the screw is a multi-blade screw.

4. The apparatus as claimed in claim 2, further comprising:
a contamination sensor for sensing a contamination degree of water;
a control part for receiving an output of the contamination sensor to judge on the contamination degree of the water so as to control a driving means; and
the driving means driving the screw in accordance with commands of the control part.
